(19) United States
(12) Patent Application Publication
(10) Pub. No.: US 2025/0323276 A1
(43) Pub. Date: Oct. 16, 2025

(54) NEGATIVE ELECTRODE ACTIVE MATERIAL, PREPARATION METHOD THEREOF, AND RECHARGEABLE LITHIUM BATTERIES

(71) Applicant: SAMSUNG SDI CO., LTD., Yongin-si (KR)

(72) Inventors: Minyeong SONG, Yongin-si (KR); Changsu SHIN, Yongin-si (KR); Hee Seon CHOI, Yongin-si (KR); Dae-Hyeok LEE, Yongin-si (KR); Soonbong CHOI, Yongin-si (KR)

(73) Assignee: SAMSUNG SDI CO., LTD., Yongin-si (KR)

(21) Appl. No.: 19/174,332

(22) Filed: Apr. 9, 2025

(30) Foreign Application Priority Data
Apr. 12, 2024 (KR) 10-2024-0049633

(51) Int. Cl. H01M 4/62; H01M 4/36; H01M 4/38; H01M 4/587; H01M 10/0525

(52) U.S. Cl. CPC H01M 4/628; H01M 4/366; H01M 4/381; H01M 4/587; H01M 10/0525

(57) ABSTRACT

Examples of the disclosure include a negative electrode active material, a method of preparing the negative electrode active material, and a rechargeable lithium battery. The negative electrode active material includes a silicon-carbon composite including secondary particles in which a plurality of nano-silicon primary particles are assembled, and an amorphous carbon coating layer on the surface of the secondary particles, and a sodium element on the surface of the nano-silicon primary particle and the amorphous carbon coating layer.

### CROSS-REFERENCE TO RELATED APPLICATION

This application claims the benefit of priority to Korean Patent Application No. 10-2024-0049633 filed in the Korean Intellectual Property Office on Apr. 12, 2024, the entire contents of which are incorporated herein by reference.

### BACKGROUND

### 1. Field

Negative electrode active materials, preparation methods thereof, and rechargeable lithium batteries are disclosed.

### 2. Description of the Related Art

With increasing use of electronic devices using batteries such as, e.g., mobile phones, notebook computers, electric vehicles, and the like, a demand for small, lightweight, and relatively high-capacity rechargeable lithium batteries are rapidly increasing.

Such rechargeable lithium batteries use crystalline carbon such as graphite as a negative electrode active material, which performance can achieve close to theoretical energy density. However, there remains a need for substantially higher energy density.

However, because silicon has a lower initial efficiency than the crystalline carbon and a large volume expansion during the charging and discharging, which causes deterioration of an electrode, which causes detachment of the electrode from a current collector, depletion of an electrolyte, and the like, the silicon-based active material exhibits deteriorated lifecycle characteristics.

### SUMMARY

Examples of the disclosure include a negative electrode active material that reduces irreversible lithium capacity losses, improve charge and discharge efficiency, and reduces or suppresses the generation of irreversible side reactants to improve battery lifecycle characteristics.

In some example embodiments, a negative electrode active material includes a silicon-carbon composite including secondary particles in which a plurality of nano-silicon primary particles are assembled, and an amorphous carbon coating layer on the surface of the secondary particles, and a sodium element on the surface of the nano-silicon primary particle and the amorphous carbon coating layer.

In some example embodiments, a method of preparing a negative electrode active material includes mixing a silicon powder and a first sodium raw material in an organic solvent to prepare a mixed solution, drying the mixed solution, mixing the dried mixed solution and the amorphous carbon precursor, and performing heat treatment, immersing the heat-treated dried mixed solution and amorphous carbon precursor in a solution including a second sodium raw material.

In some example embodiments, a rechargeable lithium battery includes a negative electrode including the negative electrode active material, a positive electrode, and an electrolyte.

By applying the negative electrode active material according to some example embodiments, the irreversible lithium capacity losses can be reduced to improve charge/discharge efficiency, and the generation of irreversible side reactants can be reduced or suppressed to improve battery lifecycle characteristics.

### BRIEF DESCRIPTION OF THE DRAWINGS

FIGS. 1 to 4 are cross-sectional views schematically illustrating rechargeable lithium batteries, according to some example embodiments.

FIGS. 5 and 6 are schematic cross-sectional views of a negative electrode active material, according to some example embodiments.

### DETAILED DESCRIPTION

Hereinafter, example embodiments will be described in detail so that those of ordinary skill in the art can readily implement the example embodiments. However, this disclosure may be embodied in many different forms and is not construed as limited to the example embodiments set forth herein.

The terminology used herein describes example embodiments only, and is not intended to limit the present disclosure. The singular expression includes the plural expression unless the context clearly dictates otherwise.

As used herein, “combination thereof” means a mixture, a laminate, a composite, a copolymer, an alloy, a blend, a reaction product, and the like of the constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., may be exaggerated for clarity, and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface.

In addition, the average particle diameter may be measured by a method well known to those skilled in the art, for example, may be measured by a particle size analyzer, or may be measured by a transmission electron microscope image or a scanning electron microscope image. Alternatively, it is possible to obtain an average particle diameter value by measuring it using a dynamic light scattering method, performing data analysis, counting the number of particles for each particle size range, and calculating from this. As used herein, when a definition is not otherwise provided, average particle diameter may mean the diameter (D₅₀) of particles having a cumulative volume of 50 volume % in the particle size distribution. As used herein, when a definition is not otherwise provided, the average particle diameter means a diameter (D₅₀) of particles having a cumulative volume of 50 volume % in the particle size distribution that is obtained by measuring the size (diameter or length of the major axis) of about 20 particles randomly in an optical micrograph.

Herein, “or” is not to be construed as an exclusive meaning, for example, “A or B” is construed to include A, B, A+B, and the like.

“Metal” is interpreted as a concept including ordinary metals, transition metals and metalloids (semi-metals).

Soft carbon refers to a carbon material that can be graphitized, and is a material that is readily graphitized by heat treatment at a high temperature, for example, about 2800° C. Hard carbon is a carbon material that cannot be graphitized or is finely graphitized by heat treatment.

When the terms “about” or “substantially” are used in this specification in connection with a numerical value, it is intended that the associated numerical value include a tolerance of +10% around the stated numerical value. The expression “up to” includes amounts of zero to the expressed upper limit and all values therebetween. When ranges are specified, the range includes all values therebetween such as increments of 0.1%.

### Negative Electrode Active Material

In some example embodiments, a negative electrode active material includes a silicon-carbon composite including secondary particles in which a plurality of nano-silicon primary particles are assembled, and an amorphous carbon coating layer on the surface of the secondary particles; and a sodium element on the surface of the nano-silicon primary particle and the amorphous carbon coating layer.

Silicon-based negative electrode active materials may present a challenge in that rapid volume changes typically occur during charging and discharging. Accordingly, in order to buffer the volume expansion of silicon, typical methods include treating silicon into nanoparticles, mixing silicon and amorphous carbon material, or coating the surface of silicon with an amorphous carbon material. However, when silicon is converted into nanoparticles, there may be a disadvantage in that oxidation of the surface of the silicon nanoparticles may become severe, and the initial irreversible lithium capacity losses may increase accordingly. Additionally, when mixing or coating silicon and amorphous carbon material, there may be a challenge in that initial irreversible lithium capacity losses are generated due to defects in the amorphous carbon itself.

Some example embodiments include a method of proceeding with pre-sodiation of introducing sodium in advance to the silicon-carbon composite in which the silicon nanoparticles and the amorphous carbon material are mixed to reduce or suppress the irreversible lithium loss, resultantly improving charge/discharge efficiency and lifecycle characteristics. The surface of the silicon nanoparticles is readily oxidized and forms silicon oxide, wherein the silicon oxide reacts with lithium during the charging to form lithium silicate, which corresponds to an irreversible reaction to stop releasing lithium again, reducing the reversible capacity of lithium. Some example embodiments may introduce sodium on the surface of the silicon nanoparticles in advance to form, for example, sodium silicate, and thus reduce irreversible lithium capacity losses, thereby effectively reducing or suppressing the irreversible reaction of the silicon nanoparticles with lithium. In addition, when lithium is adsorbed onto a defective portion of the amorphous carbon during the charging and synthesizes lithiated carbon, and the like, lithium ions are not released again, resultantly generating irreversible lithium capacity losses, but some example embodiments, because sodium is introduced in advance into the amorphous carbon to form, for example, sodium carbide, may effectively reduce or suppress the irreversible reaction of the amorphous carbon and lithium, further reducing the irreversible lithium capacity losses. Accordingly, in the negative electrode active material according to some example embodiments, capacity may be significantly increased by silicon, while effectively buffering a volume change of the silicon, and irreversible capacity losses may be significantly reduced by the silicon and amorphous carbon, improving charge/discharge efficiency. In addition, lifecycle characteristics of batteries may be improved by reducing or suppressing the generation of irreversible by-products. Furthermore, a method according to some example embodiments includes a method of using sodium, which is less expensive than lithium, to reduce the irreversible capacity losses, which is economical and commercially advantageous.

### Silicon-Carbon Composite

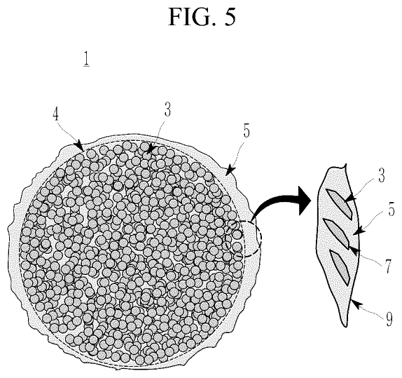

The left-hand side image of FIG. 5 is a schematic view illustrating a cross-section of the silicon-carbon composite according to some example embodiments. Referring to FIG. 5, the silicon-carbon composite 1 includes a secondary particle 4 in which a plurality of nano-silicon primary particles 3 are assembled, and an amorphous carbon coating layer 5 on the surface of the secondary particle. The secondary particle 4 is a type of core particle, and the amorphous carbon coating layer 5 may be or include a shell surrounding the secondary particle. Herein, inside the secondary particle 4, that is, between the nano-silicon primary particles 3, amorphous carbon may be filled. In other words, the nano-silicon primary particles 3 may be coated with amorphous carbon. For example, the secondary particle 4 may be embedded in an amorphous carbon matrix, and the nano-silicon primary particles 3 may be dispersed in the amorphous carbon matrix.

An average particle diameter (D₅₀) of the nano-silicon primary particles 3 may be in a range of about 10 nm to about 600 nm, for example, about 10 nm to about 500 nm, about 10 nm to about 400 nm, about 10 nm to about 300 nm, or about 10 nm to about 200 nm. When the nano-silicon primary particles 3 have an average particle diameter within any of the above ranges, excessive volume expansion may be reduced or suppressed during the charging and discharging, and disconnection of a conductive path by particle pulverization may be reduced or prevented. The average particle diameter may be measured by using, for example, a particle analyzer.

A shape of the nano-silicon primary particles 3 may not be particularly limited, and may be, for example, spherical, ellipsoidal, sheet (plate)-shaped, flake-shaped, shapeless, or fiber-shaped.

The nano-silicon primary particles 3 may include at least one of silicon, an alloy of the silicon with other metals, or partially oxidized silicon (SiOx, 0≤x≤2), and may be different from SiO₂. When SiO₂ particles, instead of the silicon primary particles 3, are used, irreversible capacity losses may be excessively high, and because SiO₂ generally has a particle diameter of several micrometers or more, achieving a substantially uniform pre-sodiation in the negative electrode active material may be challenging, there may be a small effect according to the sodium introduction, and furthermore, when SiO₂ particles are pulverized into a nano size, an Si content may be lowered due to an additional oxidation reaction, resulting in reducing capacity. In addition, SiO₂ particles have high reactivity with a sodium raw material, and thus may excessively generate a sodiation reaction and form an excessive amount of sodium silicate, the capacity may be reduced.

The amorphous carbon may include, for example, at least one of soft carbon or hard carbon, a mesophase pitch carbonized product, fired coke, or a combination thereof, for example, hard carbon. The hard carbon may have an interplanar distance of about 0.385 nm, which corresponds to a diffraction peak of a (002) crystal plane, and thus may be suitable for reversible insertion and desorption of sodium ions.

The amorphous carbon coating layer 5 on the surface of the secondary particle 4 may have a thickness in a range of about 2 nm to about 800 nm, for example, about 5 nm to about 600 nm, about 10 nm to about 400 nm, or about 20 nm to about 200 nm. The thickness of the amorphous carbon coating layer 5 may be measured, e.g., through a scanning electron microscope (SEM) or a transmission electron microscope (TEM) image on a cross-section of the silicon-carbon composite.

The silicon-carbon composite 1 may have an average particle diameter (D₅₀) of about 30 μm or less, for example, in a range of about 1 μm to about 30 μm, about 2 μm to about 25 m, about 3 μm to about 20 μm, or about 5 μm to about 15 μm. When the silicon-carbon composite 1 has an average particle diameter within any of the above ranges, energy density may be increased, and lithium ions may be readily diffused into the negative electrode active material composite, reducing battery resistance and improving rate capability. In addition, because the negative electrode active material may be reduced or suppressed, excessive increase of a specific surface area, a side reaction with an electrolyte, may be reduced as well. The average particle diameter may be, for example, measured by using a particle analyzer.

Based on 100 wt % of a total of silicon and amorphous carbon in the silicon-carbon composite, the silicon may be included in an amount in a range of about 50 wt % to about 90 wt %, for example, about 60 wt % to about 80 wt %, and the amorphous carbon may be included in an amount in a range of about 10 wt % to about 50 wt % or about 20 wt % to about 40 wt %. When the contents of the silicon and the amorphous carbon respectively satisfy any of the above respective ranges, a negative electrode active material realizing high-capacity and effectively reduced or suppressed from volume expansion may be obtained.

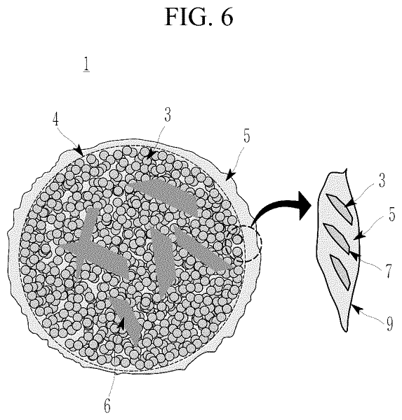

In examples, the silicon-carbon composite 1 according to some example embodiments may further include crystalline carbon 6. The left-hand side illustration of FIG. 6 shows a cross-section of a silicon-carbon composite 1 that further includes crystalline carbon 6. Referring to FIG. 6, the silicon-carbon composite 1 may, for example, include a core including the nano-silicon primary particles 3 and the crystalline carbon 6 and the amorphous carbon coating layer 5 on the surface of the core. The crystalline carbon 6 may be located inside the secondary particle 4, and accordingly, the silicon primary particles 3 and the crystalline carbon 6 may be dispersed in an amorphous carbon matrix. Likewise, the amorphous carbon may be filled between the nano-silicon primary particles 3 or between the crystalline carbon 6.

The crystalline carbon 6 may be or include natural graphite or artificial graphite and spherical, ellipsoidal, sheet-like, flake-like, shapeless, or fibrous.

The crystalline carbon 6 may be included in an amount in a range of about 1 wt % to about 20 wt %, for example, about 3 wt % to about 17 wt % or about 5 wt % to about 15 wt % based on 100 wt % of a total of silicon, amorphous carbon, and crystalline carbon. When the crystalline carbon 6 is included within any of the above content ranges, conductivity may be enhanced, thereby improving rate capability.

The silicon-carbon composite 1 may include 30 wt % to 89 wt % of the silicon, 10 wt % to 59 wt % of the amorphous carbon, and 1 wt % to 20 wt % of the crystalline carbon based on 100 wt % of a total of silicon, amorphous carbon, and crystalline carbon. For example, the silicon-carbon composite 1 may include 40 wt % to 87 wt % of the silicon, 10 wt % to 49 wt % of the amorphous carbon, and 3 wt % to 17 wt % of the crystalline carbon based on 100 wt % of a total of silicon, amorphous carbon, and crystalline carbon. Or, the silicon-carbon composite 1 may include 50 wt % to 75 wt % of the silicon, 20 wt % to 45 wt % of the amorphous carbon, and 5 wt % to 15 wt % of the crystalline carbon based on 100 wt % of a total of silicon, amorphous carbon, and crystalline carbon. Or, the silicon-carbon composite 1 may include 60 wt % to 70 wt % of the silicon, 25 wt % to 35 wt % of the amorphous carbon, and 5 wt % to 15 wt % of the crystalline carbon based on 100 wt % of a total of silicon, amorphous carbon, and crystalline carbon.

### Sodium

The right images of FIGS. 5 and 6 are schematic views enlarging the cross-sections of the negative electrode active materials according to some example embodiments. In the negative electrode active materials according to some example embodiments, sodium elements are present in the nano-silicon primary particles 3 and on the amorphous carbon coating layer 5. The sodium may be present on the surface or inside the nano-silicon primary particles 3, for example, on the surface of the nano-silicon primary particles 3. In addition, the sodium may be distributed substantially evenly or locally in the amorphous carbon coating layer 5.

As an example, the negative electrode active material may include at least one of the aforementioned silicon-carbon composite, sodium silicate, and sodium carbide.

For example, the negative electrode active material may include sodium silicate 7 on the surface of the nano-silicon primary particles 3, and sodium carbide 9 on the amorphous carbon coating layer 5. The sodium silicate and sodium carbide are not reactive with lithium, and thus do not cause side reactions, and effectively hinder or prevent lithium ions from reacting irreversibly with silicon (or oxidized silicon) or with amorphous carbon during charging, thereby improving charge/discharge efficiency and lifecycle characteristics of a battery.

The sodium silicate 7 may be represented by the chemical formula (Na₂O)·n(SiO₂), and may include at least one of Na₂SiO₃, Na₄SiO₄, Na₂Si₂O₅, Na₂Si₄O₉, or a combination thereof. The presence of sodium silicate in the negative electrode active material can be determined through X-ray diffraction analysis (XRD).

The sodium carbide 9 may be represented by Chemical Formula NaₓC, and sodium ions may be adsorbed or bonded inside amorphous carbon. The amorphous carbon coating layer 5 present on the outermost layer of the negative electrode active material particle according to some example embodiments may include sodium carbide. Accordingly, the sodium element may be substantially evenly distributed on the surface of the negative electrode active material, which can be confirmed through scanning electron microscopy-energy dispersive spectroscopy (SEM-EDS) on the surface of the negative electrode active material.

An amount of the sodium element may be in a range of about 0.1 wt % to about 20 wt %, for example about 0.5 wt % to about 15 wt %, or about 1 wt % to about 10 wt %, based on a total of 100 wt % of the silicon-carbon composite and sodium element. Additionally, the sodium element may be included in an amount in a range of about 1 at % to about 25 at %, for example, about 3 at % to about 20 at %, or about 5 at % to about 15 at %, based on a total of 100 at % of the silicon-carbon composite and the sodium element. When the sodium is included in any of the above amounts or ranges, the irreversible lithium capacity losses can be effectively reduced, thereby improving charge/discharge efficiency and lifecycle characteristics. The amount of sodium can be measured, for example, through atomic absorption spectroscopy (AAS), X-ray photoelectron spectroscopy (XPS), or SEM-EDS quantitative analysis.

### Method of Preparing Negative Electrode Active Material

In some example embodiments, a method of preparing a negative electrode active material includes (i) mixing a silicon powder and a first sodium raw material in an organic solvent to prepare a mixed solution, (ii) drying the mixed solution, (iii) mixing dried product and the amorphous carbon precursor and performing heat treatment, and (iv) immersing the heat-treated resultant in a solution including a second sodium raw material. Through this method, the aforementioned pre-sodinated silicon-carbon composite negative electrode active material may be prepared.

The step (i) may be or include a process of preparing a silicon dispersion. As an example, step (i) may include (i-1) first preparing a silicon dispersion by adding silicon powder to an organic solvent and mixing, and then (i-2) adding the first sodium raw material thereto. Herein, the mixing process may be or include a milling process using a bead mill or ball mill, and the size of the silicon particles may be reduced to nano size through the mixing process. The silicon in the prepared mixed solution may have a size of several nanometers to hundreds of nanometers.

The organic solvent may be or include an alcohol-based solvent that is readily volatilized without oxidizing the silicon powder, and may include, for example, at least one of methanol, ethanol, isopropyl alcohol, butanol, propylene glycol, or a combination thereof.

The average particle diameter (D₅₀) of the injected silicon powder may be at the micrometer or nanometer level and is not particularly limited, but may be, for example, in a range of about 10 nm to about 200 μm.

The first sodium raw material is a material for inducing pre-sodiation of silicon and may include, for example, at least one of NaOH, Na₂CO₃, or a combination thereof.

In the step (i), the silicon powder and the first sodium raw material may be mixed to have about 1 wt % to about 21 wt % of sodium based on 100 wt % of a total of silicon and sodium. Accordingly, an appropriate content of sodium may be introduced to effectively reduce irreversible capacity losses and improve electrochemical performance of batteries.

In the step (i), when preparing the mixed solution by mixing the silicon powder and the first sodium raw material in the organic solvent, crystalline carbon may be added. Description of the crystalline carbon may be the same as above. A content of the crystalline carbon added above may be in a range of about 3 wt % to about 25 wt % based on 100 wt % of a total of silicon powder and crystalline carbon. Herein, conductivity of a negative electrode may be improved, improving overall electrochemical characteristics including rate capability.

In the step (ii), the mixed solution may be dried to form the secondary particle in which the nano-silicon primary particles are assembled, wherein the secondary particle may include the first sodium raw material. In other words, the dried product may be the secondary particle in which the nano-silicon primary particles are assembled. In the step (i), when the crystalline carbon is added, the nano-silicon primary particles are assembled with the crystalline carbon, forming secondary particles.

The step (ii) may be or include, for example, a spray drying method, through which the secondary particles may be manufactured under mild conditions. The manufactured secondary particles may have a uniform particle diameter and few defects. The drying may be carried out, for example, at a temperature range of about 50° C. to about 150° C. or about 100° C. to about 140° C.

In the step (iii), about 60 wt % to about 90 wt % of the dried product, and about 10 wt % to about 40 wt % of the amorphous carbon precursor may be mixed, for example, about 60 wt % to about 80 wt % of the dried product and about 20 wt % to about 40 wt % of the amorphous carbon precursor may be mixed. Herein, because the amorphous carbon may not be included in an excessive amount in a final negative electrode active material, capacity-increasing effect by silicon and desired or improved initial efficiency may be achieved.

The amorphous carbon precursor may include, for example, at least one of coal-based pitch, meso-pitch, meso-phase pitch, petroleum-based pitch, meso-carbon pitch, coal-based oil, heavy petroleum oil, or phenol resin, furan resin, or polyimide resin.

In the step (iii), the amorphous carbon precursor is converted to amorphous carbon through the heat treatment, and this amorphous carbon may surround the secondary particle surface to form the amorphous carbon coating layer, and also be filled inside the secondary particle. In addition, during the heat treatment process, silicon oxide, for example, silicon oxide on the surface of the nano-silicon primary particle, may react with the first sodium raw material to form sodium silicate. The silicon oxide is naturally formed through a reaction of silicon with oxygen in the air, but may be removed through the reaction with sodium, which may reduce or suppress an irreversible reaction of the silicon oxide with lithium, reducing irreversible capacity losses.

The heat treatment may be performed within a temperature range of about 700° C. to about 1000° C. for about 1 hour to about 10 hours under an inert atmosphere. When the heat treatment is performed under such conditions, amorphous carbon may be effectively produced, and while oxidation or carbonization of silicon may be reduced or suppressed, pre-sodiation of the silicon may proceed.

The step (iv) may be or include a process of performing the pre-sodiation in the amorphous carbon coating layer to form a type of sodium carbide. For example, after preparing the sodium solution by adding a second sodium raw material to an organic solvent, the heat-treated resulting product may be immersed in the sodium solution for a desired or predetermined time, and subsequently removed therefrom.

The second sodium raw material is or includes a material for pre-sodinating the amorphous carbon, for example, sodium biphenylyl. The sodium biphenyl may be readily prepared at room temperature, and is configured to effectively sodinate the amorphous carbon. For example, when equal equivalents of biphenyl and sodium are added to a non-polar organic solvent such as, e.g., dimethyl ether (DME) and the like, sodium biphenyl is rapidly formed at room temperature. A conjugated biphenyl ring, which has strong electron affinity, may receive electrons from the sodium and rapidly form biphenyl radical anions, and such sodium biphenyl may readily induce sodination of amorphous carbon at room temperature.

The immersion of the heat-treated resulting product in the solution including the second sodium raw material may be performed for a substantially short time, for example, for about 0.5 minutes to about 10 minutes under mild conditions such as room temperature and a normal pressure.

The method of manufacturing the negative electrode active material may further include a washing process with an organic solvent after immersing the heat-treated resultant in the solution that includes the second sodium raw material, and then taking it out.

### Negative Electrode

In some example embodiments, a negative electrode including the aforementioned negative electrode active material is provided. The negative electrode may include a current collector and a negative electrode active material layer on the current collector, and the negative electrode active material layer may include the aforementioned negative electrode active material. The negative electrode active material layer may optionally further include other types of negative electrode active materials, and may further include a binder, a conductive material, or a combination thereof.

For example, the negative electrode according to some example embodiments may include the aforementioned negative electrode active material as a first negative electrode active material, and may include a second negative electrode active material including crystalline carbon. Herein, based on a total of 100 wt % of the first negative electrode active material and the second negative electrode active material, the first negative electrode active material may be included in an amount in a range of about 1 wt % to about 60 wt %, or about 1 wt % to about 50 wt %, about 3 wt % to about 30 wt %, or about 3 wt % to about 10 wt %, and may be appropriately mixed depending on the desired capacity.

### Binder

The binder is configured to adhere the negative electrode active material particles to each other, and also helps the negative electrode active material to adhere to the current collector. The binder may be or include a non-aqueous binder, an aqueous binder, a dry binder, or a combination thereof.

The non-aqueous binder may be or include at least one of polyvinylchloride, carboxylated polyvinylchloride, polyvinylfluoride, ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be or include at least one of a styrene-butadiene rubber, a (meth)acrylated styrene-butadiene rubber, a (meth)acrylonitrile-butadiene rubber, a (meth)acrylic rubber, a butyl rubber, a fluorine rubber, polyethyleneoxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, (meth)acrylic resin, a phenol resin, an epoxy resin, polyvinyl alcohol, and a combination thereof.

When the aqueous binder is included as the negative electrode binder, a cellulose-based compound capable of imparting viscosity may be further included. As the cellulose-based compound, one or more of carboxymethyl cellulose, hydroxypropylmethyl cellulose, methyl cellulose, or alkali metal salts thereof may be mixed and used. The alkali metal may be or include at least one of Na, K, or Li.

The dry binder may be or include a polymer material capable of being fibrous, and may be or include, for example, at least one of polytetrafluoroethylene, polyvinylidene fluoride, polyvinylidene fluoride-hexafluoropropylene copolymer, polyethylene oxide, or a combination thereof.

### Conductive Material

The conductive material is configured to impart conductivity to the electrode, and any electrically conductive material may be a conductive material unless the electrically conductive material causes a chemical change in the battery. Examples of the conductive material may include a carbon-based material such as at least one of natural graphite, artificial graphite, carbon black, acetylene black, ketjen black, carbon fiber, carbon nanofibers, carbon nanotubes, and the like; a metal-based material including at least one of copper, nickel, aluminum, silver, etc., in the form of metal powders or metal fibers; a conductive polymer such as a polyphenylene derivative; or a mixture thereof.

An amount of the negative electrode active material may be in a range of about 95 wt % to about 99.5 wt % based on 100 wt % of the negative electrode active material layer, and the content of the binder may be in a range of about 0.5 wt % to about 5 wt % based on 100 wt % of the negative electrode active material layer. For example, the negative electrode active material layer may include about 90 wt % to about 99 wt % of the negative electrode active material, about 0.5 wt % to about 5 wt % of the binder, and about 0.5 wt % to about 5 wt % of the conductive material.

### Current Collector

The negative electrode current collector may include, for example, at least one of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, and may be in the form of a foil, sheet, or foam. The negative electrode current collector may have, for example, a thickness in a range of about 1 μm to about 20 μm, about 5 μm to about 15 μm, or about 7 μm to about 10 μm.

### Rechargeable Lithium Battery

Some example embodiments include a rechargeable lithium battery including the aforementioned negative electrode, positive electrode, and electrolyte. As an example, a rechargeable lithium battery may include a positive electrode, a negative electrode, a separator between the positive electrode and the negative electrode, and an electrolyte solution. Some example embodiments include an all-solid-state rechargeable battery including the positive electrode, the negative electrode, and a solid electrolyte layer between the positive electrode and the negative electrode. Hereinafter, for convenience, the configuration of a lithium-ion battery using an electrolyte is explained in detail.

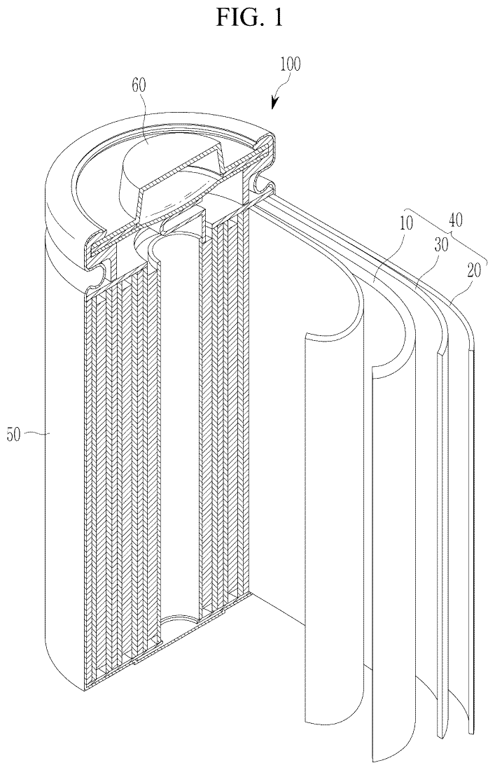

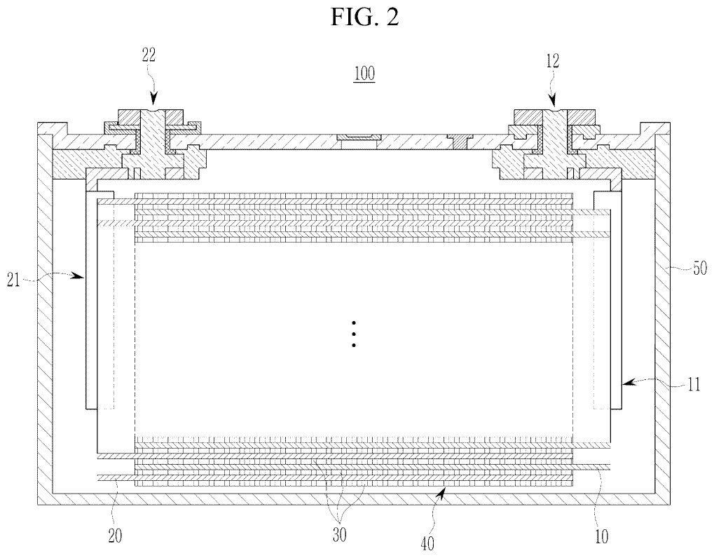

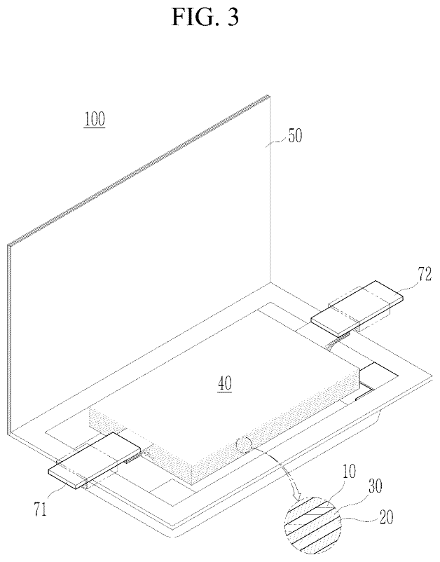

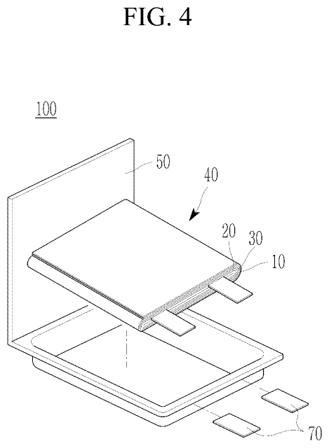

The rechargeable lithium battery may be classified into cylindrical, prismatic, pouch, coin, and the like depending on their shape. FIGS. 1 to 4 are schematic diagrams illustrating the rechargeable lithium battery according to some example embodiments, where FIG. 1 is a cylindrical battery, FIG. 2 is a prismatic battery, and FIGS. 3 and 4 are a pouch-shaped battery. Referring to FIGS. 1 to 4, the rechargeable lithium battery 100 includes an electrode assembly 40 with a separator 30 interposed between the positive electrode 10 and the negative electrode 20, and a case 50 in which the electrode assembly 40 is housed. The positive electrode 10, the negative electrode 20, and the separator 30 may be impregnated with an electrolyte solution (not shown). The rechargeable lithium battery 100 may include a sealing member 60 that seals the case 50 as shown in FIG. 1. Additionally, in FIG. 2, the rechargeable lithium battery 100 may include a positive electrode lead tab 11, a positive electrode terminal 12, a negative lead tab 21, and a negative electrode terminal 22. As shown in FIGS. 3 and 4, the rechargeable lithium battery 100 includes an electrode tab 70 illustrated in FIG. 4, or a positive electrode tab 71 and a negative electrode tab 72 illustrated in FIG. 3, the tabs 70/71/72 forming an electrical path for inducing the current formed in the electrode assembly 40 to the outside of the battery 100.

### Positive Electrode

The positive electrode for a rechargeable lithium battery may include a current collector and a positive electrode active material layer formed on the current collector. The positive electrode active material layer includes a positive electrode active material and may further include a binder and/or a conductive material.

### Positive Electrode Active Material

The positive electrode active material may include a compound (lithiated intercalation compound) capable of intercalating and deintercallating lithium. Specifically, at least one of a composite oxide of lithium and a metal including at least one of cobalt, manganese, nickel, and combinations thereof may be used.

The composite oxide may be or include a lithium transition metal composite oxide, and examples thereof may include at least one of lithium nickel-based oxide, lithium cobalt-based oxide, lithium manganese-based oxide, lithium iron phosphate-based compound, cobalt-free lithium nickel-manganese-based oxide, or a combination thereof.

As an example, a compound represented by any of the following chemical formulas may be used. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0≤α≤2); LiₐNi_{1-b-c}Mn_{b}X_{c}O_{2-α}D_{α} (0.90≤a≤1.8, 0≤b≤0.5, 0≤c≤0.5, 0≤α≤2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In the above chemical formulas, A is or includes at least one of Ni, Co, Mn, or a combination thereof; X is or includes at least one of Al, Ni, Co, Mn, Cr, Fe, Mg, Sr, V, a rare earth element, or a combination thereof; D is or includes at least one of O, F, S, P, or a combination thereof; G is or includes at least one of Al, Cr, Mn, Fe, Mg, La, Ce, Sr, V, or a combination thereof; and L¹ is or includes at least one of Mn, Al or a combination thereof.

As an example, the positive electrode active material may be or include a high nickel-based positive electrode active material having a nickel content greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of a metal excluding lithium in the lithium transition metal composite oxide. The high-nickel positive electrode active material can realize high capacity and can be applied to high-capacity, high-density rechargeable lithium batteries.

### Binder

The binder is configured to attach the positive electrode active material particles to each other, and to attach the positive electrode active material to the current collector. The binder may include at least one of polyvinylalcohol, carboxymethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, but is not limited thereto.

### Conductive Material

The conductive material is configured to impart conductivity to the electrode, and any electrically conductive material may be included as a conductive material unless the electrically conductive material causes a chemical change in the battery. Examples of the conductive material may include a carbon-based material such as at least one of natural graphite, artificial graphite, carbon black, acetylene black, ketjen black, carbon fiber, carbon nanofibers, carbon nanotubes, and the like; a metal-based material including at least one of copper, nickel, aluminum, silver, etc., in the form of metal powders or metal fibers; a conductive polymer such as a polyphenylene derivative; or a mixture thereof.

An amount of the positive electrode active material may be in a range of about 90 wt % to about 99.5 wt % based on 100 wt % of the positive electrode active material layer, and each amount of the binder and conductive material may be in a range of about 0.5 wt % to about 5 wt %, based on 100 wt % of the positive electrode active material layer.

The current collector may include Al, but is not limited thereto.

### Electrolyte

An electrolyte for a rechargeable lithium battery may include a non-aqueous organic solvent and a lithium salt.

The non-aqueous organic solvent is or constitutes a medium for transmitting ions taking part in the electrochemical reaction of a battery.

The non-aqueous organic solvent may include a at least one of carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include at least one of methyl acetate, ethyl acetate, n-propyl acetate, dimethylacetate, methylpropionate, ethylpropionate, decanolide, mevalonolactone, valerolactone, caprolactone, and the like. The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. The ketone-based solvent may include cyclohexanone and the like. The alcohol-based solvent may include at least one of ethanol and isopropyl alcohol, and the like, and the aprotic solvent may include at least one of nitriles such as R—CN (wherein R may include a C2 to C20 linear, branched, or cyclic hydrocarbon group, a double bond, an aromatic ring, or an ether bond); amides such as dimethylformamide; dioxolanes such as 1,3-dioxolane, 1,4-dioxolane, and the like; sulfolanes, and the like.

The non-aqueous organic solvent may be used alone or in combination of two or more solvents.

In examples, in the case of using a carbonate-based solvent, a mixture of cyclic carbonate and chain carbonate may be used, and the cyclic carbonate and chain carbonate may be mixed in a volume ratio of about 1:1 to about 1:9.

The lithium salt dissolves in an organic solvent, supplies a battery with lithium ions, contributes to the operation of the rechargeable lithium battery, and improves transportation of the lithium ions between positive and negative electrodes. Examples of the lithium salt may include one or more of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide; LiFSI), LiC₄F₉SO₃, LiN(CₓF₂ₓ₊₁SO₂)(C_{y}F_{2y+1}SO₂), where x and y are integers in a range of 1 to 20, lithium trifluoromethane sulfonate, lithium tetrafluoroethane sulfonate, lithium difluorobis(oxalato)phosphate (LiDFBOP), and lithium bis(oxalato) borate (LiBOB).

### Separator

Depending on the type of rechargeable lithium battery, a separator may be present between the positive electrode and the negative electrode. Examples of a suitable separator material include at least one of polyethylene, polypropylene, polyvinylidene fluoride, and multi-layers thereof such as a polyethylene/polypropylene double-layered separator, a polyethylene/polypropylene/polyethylene triple-layered separator, and a polypropylene/polyethylene/polypropylene triple-layered separator.

The separator may include a porous substrate and a coating layer including an organic material, an inorganic material, or a combination thereof positioned on one or both surfaces of the porous substrate.

The porous substrate may be or include at least one of a polymer film formed of or including any one polymer including at least one of a polyolefin such as polyethylene and polypropylene, polyester such as polyethylene terephthalate and polybutylene terephthalate, polyacetal, polyamide, polyimide, polycarbonate, polyether ketone, polyaryl ether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON (tetrafluoroethylene), and polytetrafluoroethylene, or a copolymer or mixture of two or more of them.

The organic material may include a polyvinylidene fluoride-based polymer or a (meth)acrylic-based polymer.

The inorganic material may include inorganic particles including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and the inorganic material may be mixed in one coating layer, or a coating layer including an organic material and a coating layer including an inorganic material may be stacked.

Examples and comparative examples of the present disclosure are described below. The following examples are only examples of the present disclosure, but the present disclosure is not limited to the following examples.

### Example 1

### 1. Preparation of Negative Electrode Active Material

An ethanol solvent and silicon powder were mixed in a weight ratio of 9:1 by using a bead mill to prepare a nano silicon dispersion. Graphite was added to the nano silicon dispersion to have a weight ratio of 9:1 between silicon and graphite. NaOH was added thereto to have about 1.4 wt % of Na based on 100 wt % of a total of silicon, graphite, and Na to prepare a mixed solution. This mixed solution was spray-dried at 120° C. by using a spray drier. The obtained dried product was mixed with mesophase pitch in a weight ratio of 70:30, and this mixture was heat-treated under an N₂ atmosphere at 1000° C. for 4 hours.

A 0.5 M sodium biphenyl solution was prepared by mixing equal amounts of biphenyl and sodium in a dimethyl ether (DME) solvent at room temperature. The heat-treated resultant was dipped in this solution for 1 minute and taken out, and washed with a DME solvent to prepare a negative electrode active material.

This prepared negative electrode active material was in the form of a secondary particle (core) including nano-silicon primary particles and graphite and a mesophase pitch carbonized product coating layer formed on the secondary particle surface, wherein the amorphous carbon (eg., mesophase pitch carbonized product) was filled even between the nano-silicon primary particles. Each component content was as follows; a silicon content of about 63 wt %, a graphite content of about 7 wt %, and a amorphous carbon content of 30 wt %, wherein based on 100 wt % of the negative electrode active material, the sodium content was about 1 wt %. The negative electrode active material had an average particle diameter (D₅₀) of about 10 μm, which was analyzed by a particle analyzer.

The dried product obtained through the spray drying, when examined through X-ray diffraction analysis (XRD), exhibited peaks corresponding to Na₂SiO₃ in a region of 30° to 70°, which confirmed that sodium silicate was formed on the surface of the nano-silicon primary particles.

The prepared negative electrode active material, when examined through SEM-EDS analysis, showed that sodium elements were substantially evenly dispersed on the negative electrode active material particle surface, which confirmed that sodium carbide was formed in the amorphous carbon coating layer.

### 2. Manufacturing of Rechargeable Lithium Battery Cell

97.5 wt % of the prepared negative electrode active material, 1 wt % of carboxylmethyl cellulose, and 1.5 wt % of a styrene butadiene rubber were mixed in a water solvent to prepare negative electrode active material layer slurry. The negative electrode active material layer slurry was coated on a Cu foil current collector, and dried and compressed to form a negative electrode active material layer, thereby manufacturing a negative electrode.

Between the negative electrode and a lithium metal counter electrode, a polytetrafluoroethylene separator was interposed, and an electrolyte was injected to manufacture a half-cell. The electrolyte was prepared by dissolving 1 M LiPF₆ in a mixed solvent of ethylene carbonate and dimethyl carbonate in a volume ratio of 3:7.

### Example 2

A negative electrode active material and a half-cell were manufactured substantially in the same manner as in Example 1 with a difference that the mixed solution was prepared by adding NaOH to have about 7.5 wt % of Na based on 100 wt % of the total of silicon, graphite, and Na, so that the sodium content was changed to about 5 wt % based on 100 wt % of the final negative electrode active material.

### Example 3

A negative electrode active material and a half-cell were manufactured substantially in the same manner as in Example 1 with a difference that the mixed solution was prepared by adding NaOH to have about 15.9 wt % of Na based on 100 wt % of the total of silicon, graphite, and Na, so that the sodium content was changed to about 10 wt % based on 100 wt % of the final negative electrode active material.

### Example 4

A negative electrode active material and a half-cell were manufactured substantially in the same manner as in Example 1 with a difference that graphite was not mixed in the nano silicon dispersion. The negative electrode active material of Example 4 contains 70 wt % silicon and 30 wt % amorphous carbon based on 100 wt % of the total of silicon and amorphous carbon, and it includes 1 wt % sodium based on 100 wt % of the negative electrode active material.

### Comparative Example 1

A negative electrode active material and a half-cell were manufactured substantially in the same manner as in Example 1 with a difference that the silicon-carbon composite was prepared by not adding NaOH to prepare the mixed solution and not dipping the heat-treated resultant product in the sodium biphenyl solution, that is, without the sodiation. The negative electrode active material of Comparative Example 1 contains 63 wt % silicon, 7 wt % graphite and 30 wt % amorphous carbon based on 100 wt % of the total of silicon, graphite and amorphous carbon, and it does not include sodium.

### Evaluation Example 1: Initial Charge/Discharge Efficiency

The rechargeable lithium battery cells of Examples 1 to 3 and Comparative Example 1 were charged to 4.45 V at a constant current of 0.2 C and to 0.05 C at the constant voltage and then, discharged to 3.0 V at 0.2 C at 25° C. to proceed with initial charging and discharging, and a ratio of initial discharge capacity to initial charge capacity was then calculated and shown as efficiency in Table 1.

TABLE 1

| | Initial charge/discharge efficiency (%) |
|---|---|
| Example 1 | 88.1 |
| Example 2 | 91.6 |
| Example 3 | 93.2 |
| Comparative Example 1 | 85.0 |

Referring to Table 1, the cells of Examples 1 to 3 exhibited high initial charge/discharge efficiency, compared to the cell of Comparative Example 1. The examples, in which a silicon-carbon composite prepared by proceeding with pre-sodiation was applied as a negative electrode active material, were understood to effectively reduce or suppress the irreversible lithium loss, and thus exhibit improved charge/discharge efficiency.

While this disclosure has been described in connection with what is presently considered to be practical example embodiments, it is to be understood that the disclosure is not limited to the disclosed example embodiments. On the contrary, this disclosure is intended to cover various modifications and equivalent arrangements included within the spirit and scope of the appended claims.

Description of Symbols:

| | |
|---|---|
| 100: rechargeable lithium battery | 10: positive electrode |
| 11: positive electrode lead tab | 12: positive electrode terminal |
| 20: negative electrode | 21: negative electrode lead tab |
| 22: negative electrode terminal | 30: separator |
| 40: electrode assembly | 50: case |
| 60: sealing member | 70: electrode tab |
| 71: positive electrode tab | 72: negative electrode tab |

What is claimed is:

1. A negative electrode active material, comprising:
a silicon-carbon composite including secondary particles in which a plurality of nano-silicon primary particles are assembled, and an amorphous carbon coating layer on the surface of the secondary particles; and
a sodium element in the nano-silicon primary particles and in the amorphous carbon coating layer.

2. The negative electrode active material as claimed in claim 1, wherein the sodium element is included in an amount of about 0.1 wt % to about 20 wt % based on a total of 100 wt % of the silicon-carbon composite and the sodium element.

3. The negative electrode active material as claimed in claim 1, wherein the sodium element is included in an amount of about 1 at % to about 25 at % based on a total of 100 at % of the silicon-carbon composite and the sodium element.

4. The negative electrode active material as claimed in claim 1, wherein the sodium element is substantially evenly distributed on the surface of the negative electrode active material.

5. The negative electrode active material as claimed in claim 1, further comprising:
sodium silicate on the surface of the nano-silicon primary particles, and
sodium carbide in the amorphous carbon coating layer.

6. The negative electrode active material as claimed in claim 1, wherein the amorphous carbon is filled between the nano-silicon primary particles.

7. The negative electrode active material as claimed in claim 1, wherein the negative electrode active material comprises about 50 wt % to about 90 wt % of silicon and about 10 wt % to about 50 wt % of amorphous carbon based on a total of 100 wt % of silicon and amorphous carbon in the silicon-carbon composite.

8. The negative electrode active material as claimed in claim 1, wherein:
a thickness of the amorphous carbon coating layer on the surface of the secondary particle is in a range of about 2 nm to about 800 nm,
an average particle diameter (D₅₀) of the nano-silicon primary particles is in a range of about 10 nm to about 600 nm, and
an average particle diameter (D₅₀) of the silicon-carbon composite is in a range of about 1 μm to about 30 μm.

9. The negative electrode active material as claimed in claim 1, wherein the silicon-carbon composite further comprises crystalline carbon.

10. The negative electrode active material as claimed in claim 9, wherein the silicon-carbon composite comprises a core including the nano-silicon primary particles and the crystalline carbon, and the amorphous carbon coating layer is on the surface of the core.

11. The negative electrode active material as claimed in claim 9, wherein the crystalline carbon is included in an amount of about 1 wt % to about 20 wt % based on a total of 100 wt % of silicon, amorphous carbon, and crystalline carbon.

12. A method of preparing a negative electrode active material, the method comprising:
mixing a silicon powder and a first sodium raw material in an organic solvent to prepare a mixed solution,
drying the mixed solution,
mixing a dried product of the dried mixed solution and an amorphous carbon precursor, and performing heat treatment to form a mixture, and
immersing the heat-treated mixture in a solution including a second sodium raw material.

13. The method as claimed in claim 12, wherein:
the organic solvent comprises an alcohol-based solvent,
an average particle diameter (D₅₀) of the silicon powder is in a range of about 10 nm to about 200 μm, and
the first sodium raw material comprises at least one of NaOH and Na₂CO₃.

14. The method as claimed in claim 12, wherein mixing the silicon powder and the first sodium raw material comprises:
preparing a silicon dispersion by adding the silicon powder to the organic solvent and mixing the silicon powder and the organic solvent, and
adding the first sodium raw material to the silicon dispersion.

15. The method as claimed in claim 12, wherein:
when preparing the mixed solution by mixing the silicon powder and the first sodium raw material in the organic solvent, crystalline carbon is added, and
an amount of the added crystalline carbon is in a range of about 3 wt % to about 25 wt % based on a total of 100 wt % of the silicon powder and the crystalline carbon.

16. The method as claimed in claim 12, wherein drying the mixed solution comprises spray-drying the mixed solution at a temperature in a range of about 50° C. to about 150° C.

17. The method as claimed in claim 12, wherein mixing the dried product of the dried mixed solution and the amorphous carbon precursor comprises mixing about 60 wt % to about 90 wt % of the dried product and about 10 wt % to about 40 wt % of the amorphous carbon precursor.

18. The method as claimed in claim 12, wherein the heat treatment is performed at a temperature range of about 700° C. to about 1000° C.

19. The method as claimed in claim 12, wherein:
the second sodium raw material comprises sodium biphenyl, and
the immersing of the heat-treated mixture in the solution including the second sodium raw material is carried out for about 0.5 minutes to about 10 minutes.

20. A rechargeable lithium battery, comprising:
a negative electrode including the negative electrode active material as claimed in claim 1,
a positive electrode, and
an electrolyte.
